(19) United States
(12) Patent Application Publication
(10) Pub. No.: US 2004/0255529 A1
(43) Pub. Date: Dec. 23, 2004

(54) Container with windows

(76) Inventor: Gunter Pielmeier, Bogen (DE)

Correspondence Address: Gerald Levy, Pitney, Hardin, Kipp & Szuch LLP, 685 Third Avenue, New York, NY, 10017, US

(21) Appl. No.: 10/817,666

(22) Filed: Apr. 2, 2004

(30) Foreign Application Priority Data
Apr. 3, 2003 (DE) 10315263.6-25

(51) Int. Cl. E06B 1/04; G03B 19/00

(52) U.S. Cl. 52/212; 52/217

(57) ABSTRACT

The invention concerns a container, such as a residential container, for instance, with built-in windows, doors, etc., which can be equipped with shutter frames and shutters, in which the connection of the container wall opening to the window frame is effected by means of an interposed, wraparound installation frame, which is connected mechanically to the window frame or shutter frame, on the one hand, and to the edge of the container wall opening, on the other hand.

### BACKGROUND OF THE INVENTION

The invention concerns a container according to the main clause of claim 1. Containers, such as residential containers or the like, garages, prefabricated houses and garden sheds, etc., that is, buildings with thin walls that have windows and/or doors, are known to the art. Due to the relatively thin walls of such buildings, it is extremely difficult and time-consuming to mount shutter frames and shutters. Attempts have been made to connect the container walls directly to the window section and to provide for an additional cutting of the shutter frames to fit the window opening and to produce and utilize specialized sections for the window frames. It is readily apparent that such solutions are unsuitable and also too expensive.

### SUMMARY OF THE INVENTION

Thus, the object of the invention is to propose a connection between the container wall and the window frame, both with and without built-on shutter frames, which can be universally used in thin-walled buildings and is easy to install.

The particular advantage of the invention lies in the fact that it avoids the use of specialized sections. Instead, normal window frame sections can be used. Another advantage lies in the ease of producing complete window units, with and without shutter frames, which can be used in the window openings of the container, which are often extremely think-walled, and in the universal applicability of the invention-specific solution for containers, garages, prefabricated houses, etc. Moreover, the low-cost production can also be performed on site. In the following, the invention as it is described in the claims is explained in more detail with the aid of the execution example depicted in the Figures.

### BRIEF DESCRIPTION OF THE DRAWINGS

FIG. 1 is a cross-section view of the connection between the container wall and the window frame;

FIG. 2 is a cross-section view of the connection per FIG. 1, with a built-on shutter frame; and

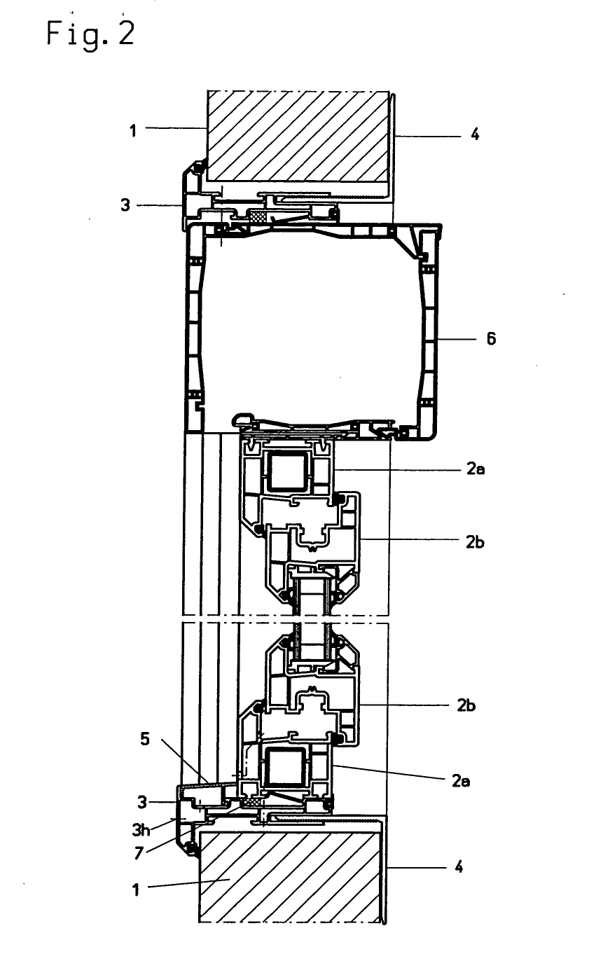

FIG. 3 is a cross-section view of the installation frame.

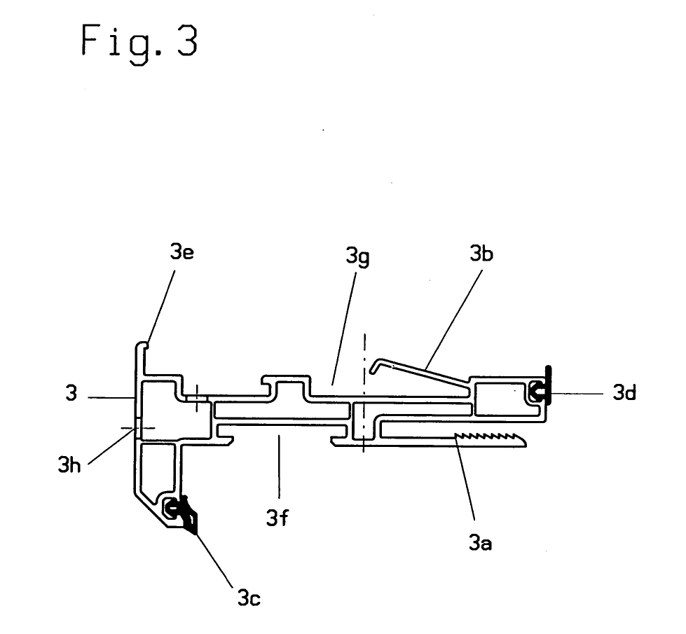

### DETAILED DESCRIPTION OF THE INVENTION

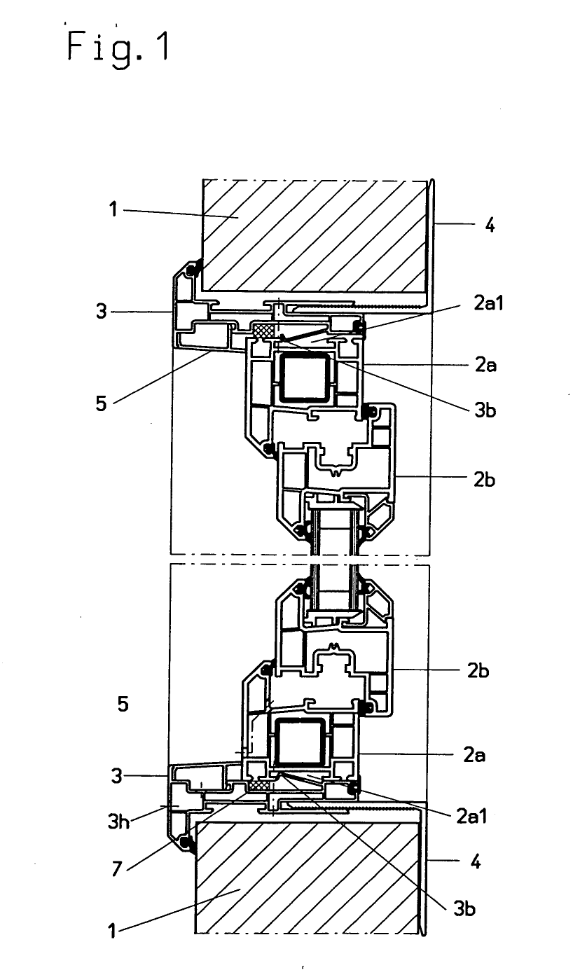

As can be seen in FIG. 1, the window, consisting of the window frame 2a and window leaves 2b of standard construction, is connected to the container wall 1 by means of an interposed installation frame 3, as follows. Initially, the prefabricated window is connected to the wraparound installation frame 3 as a single installation unit in that the elastic snap-in bracket 1b of the installation frame is snapped into the connecting groove 2a1 of the window frame section. Thereafter, the installation unit so formed is inserted from the outer side of the container (from the left, in the figure) into the window opening of the container and then fixed and locked into position from the inside by means of the back square 4, which simultaneously compensates for the different wall thicknesses and tolerances.

If a shutter frame 6 is to be installed, it is interposed between the upper edge of a window frame 2, which is made of normal, that is, widely available and usable window sections, and the upper edge of the installation frame 3, which again creates a single installation unit, and is then inserted into the window opening of the container wall 1 and fixed and locked into position with the back square 4. The installation work is then completed.

A cover section 5 is provided on the left, right and lower sides of the installation frame to cover the water drainage groove 3h. On the upper side, this groove is needed to receive the edge 6a of the shutter frame 6 and simultaneously seal it off from the outside. This cover section is designed as a multi-chamber section with a snap-in groove 3a for the back square 4 and a snap-in bracket 3b for the window frame 2a, as well as one groove 3c for an outside sealing section and another groove 3d for an inside sealing section, plus a window groove 3a for the window frame 2a or the edge 6a of the shutter frame 6 and one groove 3f for a fastening anchor and another groove 1g for a sealing band 7.

The complete installation unit, consisting of window frame, window leaves, possibly a shutter frame, plus the installation frame and back square, can be made advantageously of plastic. Nonetheless, other materials or combinations of different materials can be used for producing the installation unit.

1. The invention concerns a container with built-in windows and/or doors, etc., which can be equipped with shutter frames and shutters, characterized in that a wraparound installation frame (3), which is connected to the window frame (2a) as a single installation unit and equipped on the interior side with a back square (4) that is connected to the installation frame (3) and can be adjusted to the thickness of the container wall, is provided between the container wall (10) and the window frame (2); and the groove (3a) of the installation frame (3) is closed on its right, left and lower sides by a cover section but is open on the upper side to receive and cover the left corner of the shutter frame; and the installation frame (3) is connected to the window frame (2) and the shutter frame (6) as a single installation unit prior to being mounted to the container wall opening (1).

2. Container according to claim 1, characterized in that a shutter frame (6) is interposed between the upper side of the window frame (2) and the opposite upper side of the installation frame (3).

3. Container according to claims 1, characterized in that the back square (4) is connected to the installation frame (3) and this latter to the window frame by means of an elastic snap-in bracket (1b) which snaps into a connecting groove (2a1) of the window frame (2).
